(19) United States
(12) Patent Application Publication
(10) Pub. No.: US 2025/0287912 A1
(43) Pub. Date: Sep. 18, 2025

(54) Non-Spill Pet Food Bowl

(71) Applicant: Reiko Kobayashi, San Francisco, CA (US)

(72) Inventor: Reiko Kobayashi, San Francisco, CA (US)

(21) Appl. No.: 18/603,971

(22) Filed: Mar. 13, 2024

(51) Int. Cl. A01K 5/01; A46B 9/02

(52) U.S. Cl. CPC A01K 5/0135; A46B 9/025; A46B 2200/3073

(57) ABSTRACT

A non-spill pet food bowl includes a base portion, a bowl portion, and a rim portion. The rim portion is positioned about an upper section of the bowl portion and forms an orifice. The bowl portion includes a bottom wall and an outer side wall that defines a bowl diameter. The rim portion includes an inner rim edge that is positioned about the orifice and defines an orifice diameter. The orifice diameter is less than the bowl diameter such that the rim portion extends inwardly from the outer side wall to minimize or prevent inadvertent displacement of pet food up and over the outer side wall.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet food bowls and dishes and more particularly pertains to a new non-spill pet food bowl for preventing the pushing of pet food up and out of the bowl when a pet eats the food. It is not uncommon when pets, such as dogs, cats, and similar domestic animals, eat food in a bowl or dish, for the food to be pushed out of the bowl. For example, when a pet eats pet food, for example, dry food or kibble, the pet noses around in the food when trying to eat it. As the pet noses or roots around, usually near the center of the bowl, the pet inadvertently pushes the surrounding food pieces outwardly toward the sides of the bowl. If the bowl is fairly full of food, or if the pet has a relatively large snout, or if the bowl has a low or inclined side wall, it is relatively easy for the pet to push the food pieces over the brim of the bowl and out of the bowl, thereby creating a mess that the pet owner has to clean up. This can be especially messy in the case of wet food. In addition, most pet food bowls have a non-slip base to prevent the bowl from being moved around while the pet eats. While this resistance keeps the bowl in one place and helps the pet eat, it unfortunately makes it easier for the pet to push food out since the food moves but the bowl does not. In addition, it is not uncommon for pet owners to accidentally bump or kick pet food bowls, which can also cause food to be knocked out of the bowl. It would therefore be advantageous to have a bowl that prevents or minimizes such inadvertent displacement of food.

### (2) Description of Related Art Including Information Disclosed Under 37 CFR 1.97 and 1.98

The prior art relates to pet food bowls and dishes. The prior art, as best understood, does not disclose a pet food bowl that has an inwardly-curved rim portion to prevent or minimize inadvertent pushing of food out of the bowl.

### BRIEF SUMMARY OF THE INVENTION

An embodiment of the disclosure meets the needs presented above in a non-spill pet food bowl generally comprising a base portion, a bowl portion, and a rim portion. The bowl portion is seated on the base portion. The rim portion is positioned about an upper section of the bowl portion and forms an orifice to permit access to the interior of the bowl portion. The bowl portion includes a bottom wall and an outer side wall that extends transverse to the bottom wall and defines a bowl diameter. The rim portion includes an inner rim edge that is positioned about the orifice and defines an orifice diameter. The orifice diameter is less than the bowl diameter such that the rim portion extends inwardly from the outer side wall to minimize or prevent inadvertent displacement of pet food up and over the outer side wall, such as during eating of the pet food by the pet or upon the bowl being struck by the pet or the pet owner. In other words, the rim portion functions much like an overhanging roof or retaining wall to prevent the food from proceeding out of the bowl.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a is a perspective view of a non-spill pet food bowl according to an embodiment of the disclosure.

FIG. 2 is a side view of an embodiment of the disclosure.

FIG. 3 is a cross-sectional view of an embodiment of the disclosure.

FIG. 4 is a side view of an embodiment of the disclosure in use.

FIG. 5 is a side view of an embodiment of the disclosure in use.

### DETAILED DESCRIPTION OF THE INVENTION

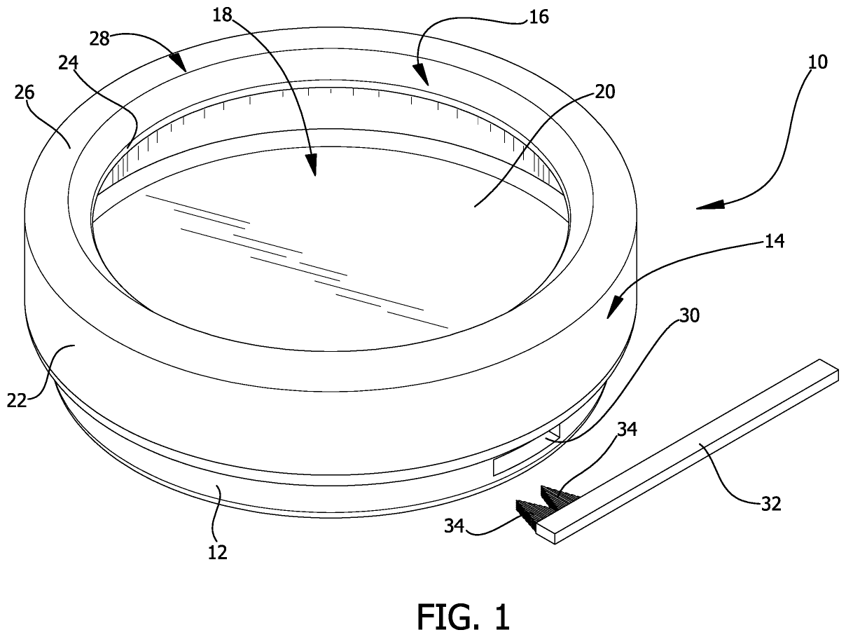

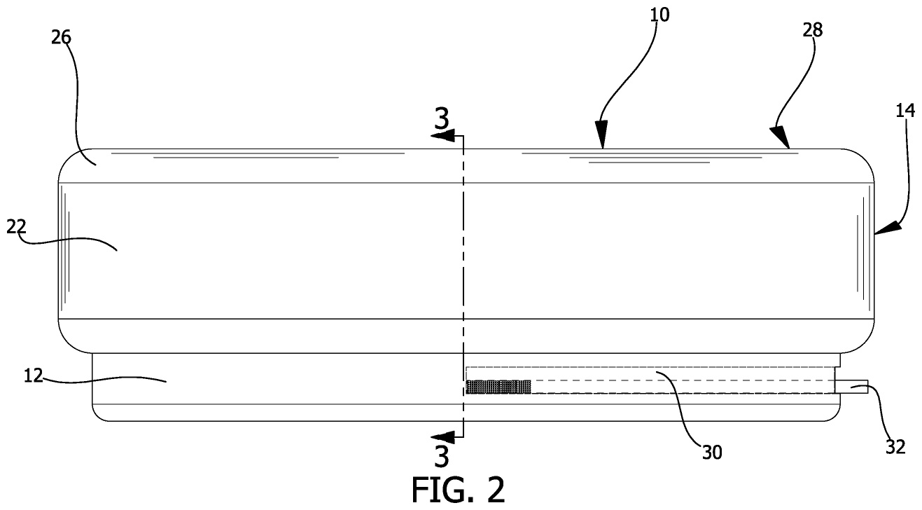

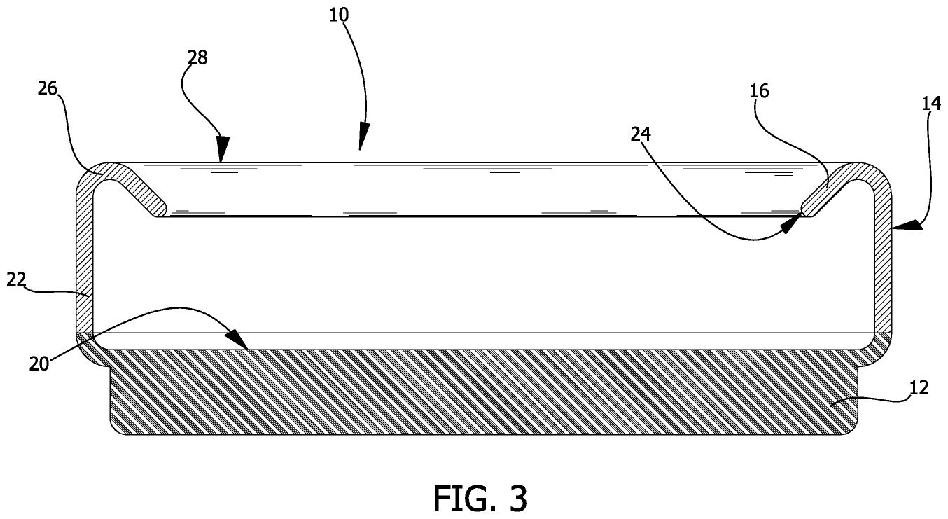

With reference now to the drawings, and in particular to FIGS. 1 through 5 thereof, a new non-spill pet food bowl embodying the principles and concepts of an embodiment of the disclosure and generally designated by the reference numeral 10 will be described.

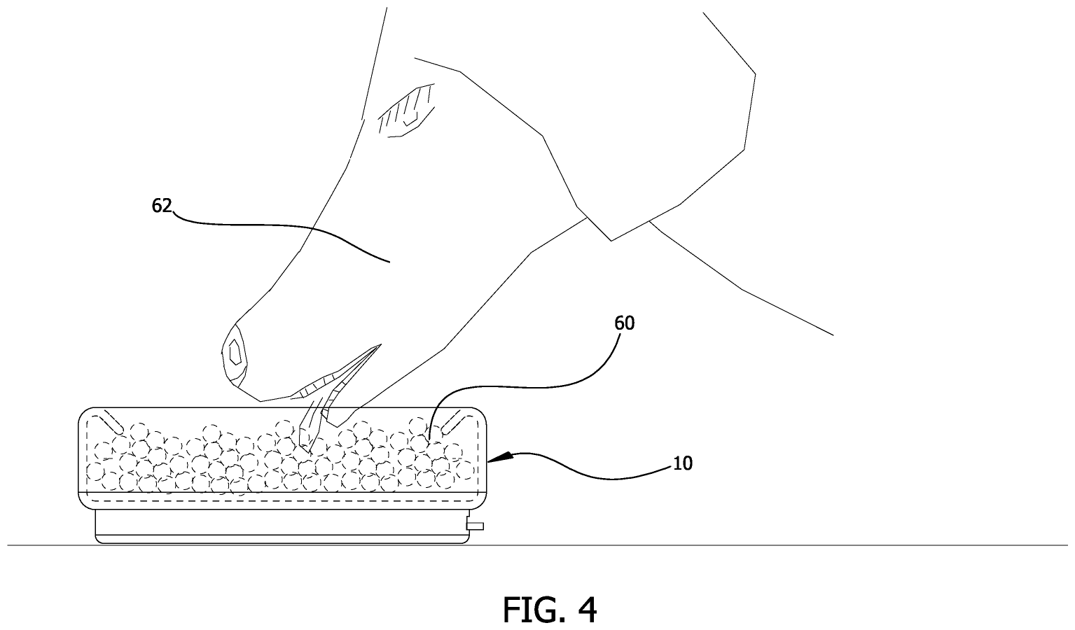

As best illustrated in FIGS. 1 through 5, the non-spill pet food bowl 10 generally comprises a base portion 12, a bowl portion 14, and a rim portion 16. The bowl portion 14 is seated on the base portion 12. The rim portion 16 is positioned about an upper section of the bowl portion 14 and forms an orifice 18 to permit access to the interior of the bowl portion 14. The bowl portion 14 includes a bottom wall 20 and an outer side wall 22 that extends transverse to the bottom wall 20 and defines a bowl diameter. The rim portion 16 includes an inner rim edge 24 that is positioned about the orifice 18 and defines an orifice diameter. The orifice diameter is less than the bowl diameter such that the rim portion 16 extends inwardly from the outer side wall 22 to minimize or prevent inadvertent displacement of pet food 60 up and over the outer side wall 22, such as during eating of the pet food 60 by the pet 62, as shown in FIG. 4, or upon the bowl being struck by the pet 62 or the pet owner.

In accordance with at least one possible embodiment, the rim portion 16 extends at a downward angle with respect to the outer side wall 22 toward the interior of the bowl portion 14, such that the inner rim edge 24 is positioned closer to the bottom wall 20 than any other section of the rim portion 16.

In accordance with at least one possible embodiment, the non-spill pet food bowl 10 further includes a curved transition portion 26 positioned to connect the outer side wall 22 to the rim portion 16 and designed to provide a convex, rounded brim 28 to protect a face and neck of a pet 62 eating pet food 60 in the bowl portion 14.

In accordance with at least one possible embodiment, the base portion 12 includes a slip-resistant material such as plastic, rubber, or an elastomeric material.

In accordance with at least one possible embodiment, the base portion 12 includes a compartment 30 therein designed to store a cleaning brush 32 or similar device designed to clean under the rim portion 16.

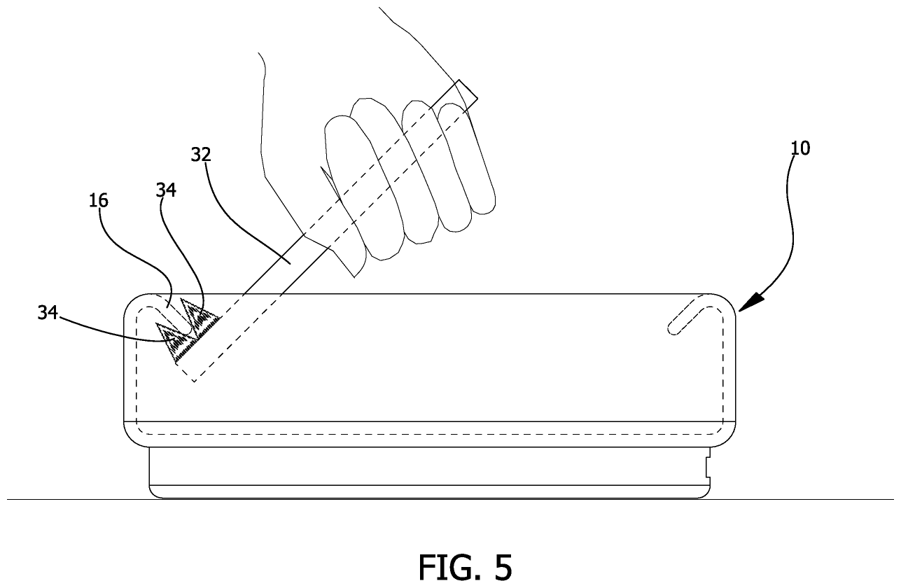

In accordance with at least one possible embodiment, the non-spill pet food bowl 10 is in combination with a cleaning brush 32 or similar device designed to clean under the rim portion 16, wherein the cleaning brush 32 includes at least two separate groups of bristles 34 designed to permit a user to simultaneously clean an outer surface and an inner surface of the rim portion 16, as shown in FIG. 5. By having a cleaning brush 32 stored in the base portion 12, the pet owner has quick and easy access to a cleaning device to keep the rim portion 16 clean and hygienic on a regular basis without having to clean the entire bowl.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present. unless the context clearly requires that there be only one of the elements.

1. A non-spill pet food bowl comprising:
a base portion;
a bowl portion seated on said base portion;
a rim portion disposed about an upper section of said bowl portion and forming an orifice to permit access to the interior of said bowl portion;
said bowl portion comprising a bottom wall and an outer side wall extending transverse to said bottom wall and defining a bowl diameter, the bowl diameter being greater than a maximum outer diameter of the base such that the bottom wall extends outwardly at a top of the base defining a ridge extending laterally from the top of the base;
said rim portion comprising an inner rim edge being disposed about said orifice and defining an orifice diameter; and
said orifice diameter being less than said bowl diameter such that said rim portion extends inwardly from said outer side wall to minimize or prevent inadvertent displacement of pet food up and over the outer side wall.

2. The non-spill pet food bowl of claim 1, wherein said rim portion extends at a downward angle with respect to said outer side wall toward the interior of said bowl portion, such that said inner rim edge is disposed closer to said bottom wall than any other section of said rim portion.

3. The non-spill pet food bowl of claim 2, further comprising a curved transition portion disposed to connect said outer side wall to said rim portion and configured to provide a convex, rounded brim to protect a face and neck of a pet eating pet food in said bowl portion.

4. The non-spill pet food bowl of claim 3, wherein said base portion comprises a slip-resistant material comprising plastic, rubber, or an elastomeric material.

5. The non-spill pet food bowl of claim 4, wherein said base portion comprises a compartment therein configured to store a cleaning brush configured to clean under said rim portion.

6. The non-spill pet food bowl of claim 5, in combination with the cleaning brush configured to clean under said rim portion, wherein said cleaning brush comprises at least two separate groups of bristles configured to permit a user to simultaneously clean an outer surface and an inner surface of said rim portion.

7. The non-spill pet food bowl of claim 1, wherein said rim portion extends at a downward angle with respect to said outer side wall toward the interior of said bowl portion, such that said inner rim edge is disposed closer to said bottom wall of said bowl portion than any other section of said rim portion.

8. The non-spill pet food bowl of claim 1, further comprising a curved transition portion disposed to connect said outer side wall to said rim portion and configured to provide a convex, rounded brim to protect a face and neck of a pet eating pet food in said bowl portion.

9. The non-spill pet food bowl of claim 1, wherein said base portion comprises a slip-resistant material comprising plastic, rubber, or an elastomeric material.

10. The non-spill pet food bowl of claim 1, wherein said base portion comprises a compartment therein configured to store a cleaning brush or configured to clean under said rim portion.

11. The non-spill pet food bowl of claim 1, in combination with a cleaning brush configured to clean under said rim portion, wherein said cleaning brush comprises at least two separate groups of bristles configured to permit a user to simultaneously clean an outer surface and an inner surface of said rim portion.
